(19) United States
(12) Patent Application Publication
(10) Pub. No.: US 2013/0302615 A1
(43) Pub. Date: Nov. 14, 2013

(54) RESIN BLEND FOR MELTING PROCESS

(71) Applicants: Houng Sik Yoo, Seoul (KR); Jin Young Ryu, Daejeon (KR); Hak Shin Kim, Daejeon (KR); Eun Joo Choi, Daejeon (KR); Young Jun Hong, Daejeon (KR)

(72) Inventors: Houng Sik Yoo, Seoul (KR); Jin Young Ryu, Daejeon (KR); Hak Shin Kim, Daejeon (KR); Eun Joo Choi, Daejeon (KR); Young Jun Hong, Daejeon (KR)

(73) Assignee: LG CHEM, LTD., Seoul (KR)

(21) Appl. No.: 13/879,487

(22) PCT Filed: Oct. 14, 2011
(86) PCT No.: PCT/KR11/07679

§ 371 Date: Aug. 2, 2013

(30) Foreign Application Priority Data
Oct. 14, 2010 (KR) 10-2010-0100468
Oct. 14, 2011 (KR) 10-2011-0105368
Oct. 14, 2011 (KR) 10-2011-0105370

(51) Int. Cl. C08L 33/20

(52) U.S. Cl. CPC C08L 33/20
USPC 428/407; 428/420; 525/208; 525/206

(57) ABSTRACT

The present invention relates to a resin blend for a melting process, to a method for preparing same, and to a resin-molded article having a specific layer separation structure, the resin blend comprising a first resin and a second resin, wherein the second resin comprises a polymer resin having an organic functional group containing one or more oxygen atoms, and has a melt viscosity difference of 0.1 to 3,000 pa*s with respect to the first resin at a shear rate of 100 to 1,000 s⁻¹ and a processing temperature of the resin blend. The resin blend allows a resin-molded article to have enhanced mechanical properties and surface hardness, and exhibits the effects of reducing a processing time, increasing productivity and reducing production cost by eliminating an additional surface coating step.

### BACKGROUND

1. Field of the Invention

The present application relates to a resin blend for a melting process, a pellet, a method of preparing a resin-molded article using the same, and a resin-molded article, and, more particularly, to a resin blend for a melting process capable of improving mechanical properties and surface hardness of a molded article and also exhibiting effects of reducing a processing time, enhancing productivity and cutting the production cost by eliminating an additional surface coating step, a method of preparing a resin-molded article using the same, and a resin-molded article.

2. Discussion of Related Art

Plastic resins are easily processed, and have excellent physical properties such as tensile strength, elastic modulus, heat resistance and impact resistance. Therefore, the plastic resins have been used in the field of various applications such as parts of an automobile, helmets, parts of electronic equipment, parts of a spinning machine, toys, or pipes.

In particular, since electric home appliances are used in living spaces, the plastic resins require functions of the electric home appliances themselves, and functions as in interior decorations as well. Also, since parts of an automobile and toys come in direct contact with human bodies, the plastic resins should be environmentally friendly and have excellent surface hardness. However, when plastic resins are exposed to external environments for a certain period of time, the plastic resins are generally decomposed and discolored easily by oxygen in the air, ozone, light and the like. Therefore, the plastic resins have a problem in that they are easily fragile due to low weather resistance and very low impact strength. As a result, a method of applying an additional painting or plating process to make up for the weak points of the plastic resins and improve surface characteristics has been generally used. However, such a painting or plating process has problems in that it may degrade efficiency and economic feasibility of a process of preparing a plastic resin, and use of the painting or plating process results in generation of a large amount of toxic substances during the process itself or disposal of products.

To solve the problems, various methods have been proposed to improve surface characteristics of plastic resins without using the painting or plating process. A method of adding inorganic particles into a plastic resin has been proposed to improve physical properties such as wear resistance and hardness. However, such a method has problems in that processability of the plastic resin may be degraded and a decrease in impact strength and gloss may be caused by addition of the inorganic particles. Also, a method of further adding a resin having high hardness or excellent heat resistance has been proposed to improve surface characteristics of a plastic resin. However, such a method has problems in that it requires an additional process such as curing a product after an injection process, and surface hardness of the product is not improved to a desired level.

Accordingly, there is an increasing demand for development of methods capable of enhancing efficiency and economic feasibility of the process without performing a process of painting or plating a plastic resin, and improving mechanical properties and surface hardness of a molded article as well.

### SUMMARY OF THE INVENTION

The present application is directed to providing a resin blend for a melting process capable of improving mechanical properties and surface hardness of a molded article and also exhibiting effects of reducing a processing time, enhancing productivity and cutting the production cost by eliminating an additional surface coating step.

Also, the present application is directed to providing a pellet prepared using the resin blend for a melting process.

In addition, the present application is directed to providing a method of preparing a resin-molded article using the resin blend for a melting process.

Furthermore, the present application is directed to providing a resin-molded article having a layer separation structure and exhibiting improved surface hardness.

One aspect of the present application provides a resin blend for a melting process including a first resin and a second resin. Here, the second resin includes a polymer resin having an organic functional group containing one or more oxygen atoms, and has a melt viscosity difference of 0.1 to 3,000 pa*s with respect to the first resin at a shear rate of 100 to 1,000 s⁻¹ and a processing temperature of the resin blend.

Another aspect of the present application provides a pellet including a core including a first resin and a shell including a second resin. Here, the second resin includes a polymer resin having an organic functional group containing one or more oxygen atoms, and has a melt viscosity difference of 0.1 to 3,000 pa*s with respect to the first resin at a shear rate of 100 to 1,000 s⁻¹ and a processing temperature of the resin blend.

Still another aspect of the present application provides a melt-processed resin-molded article including a first resin layer, a second resin layer formed on the first resin layer, and an interfacial layer which includes a first resin and a second resin and which is formed between the first resin layer and the second resin layer. Here, the second resin layer includes a polymer resin having an organic functional group containing one or more oxygen atoms.

Still another aspect of the present application provides a melt-processed resin-molded article including a first resin layer, and a second resin layer formed on the first resin layer. Here, components of the first resin layer on a surface of the second resin layer are detected by means of an infrared (IR) spectrometer, and the second resin layer includes a polymer resin having an organic functional group containing one or more oxygen atoms.

Yet another aspect of the present application provides a method of preparing resin-molded article. Here, the method includes melt-processing the resin blend.

Hereinafter, the resin blend for a melting process, the pellet, the method of preparing a resin-molded article using the same, and the resin-molded article according to specific exemplary embodiments of the present application will be described in further detail.

In the present application, the term “blend” means a case in which a first resin and a second resin are uniformly mixed in one matrix, and a case in which a pellet formed of the first resin and a pellet formed of the second resin are uniformly mixed. For example, when the first resin and the second resin are uniformly mixed in the one matrix, it is meant that the first resin and the second resin are uniformly mixed in one pellet, and then present in the form of a composition.

The term “melt processing” refers to a process of processing a resin by melting the resin at a temperature greater than or equal to a melting temperature (Tₘ), for example, injection, extrusion, blowing or foaming

The term “layer separation” means a case in which a layer-separated region (for example, a second resin-rich region) form a separate layer which may be observed separately from the remaining resin region (for example, a first resin-rich region). That is, a structure formed by the layer separation is different from a structure in which the remaining resin region and the layer-separated region are partially distributed in an entire resin blend, for example, a sea-island structure. For example, the remaining resin region and the layer-separated region may be continuously present as separate layers. Such layer separation is preferably performed by separating a certain structure into two layers. However, the structure may be separated into three layers, as necessary.

The present inventors have experimentally found that, when certain first and second resins are used herein, layer separation may easily occur during a process such as extrusion or injection due to different physical properties of the first and second resins, for example, a difference in physical properties such as hydrophobicity, surface energy, glass transition temperature or melt viscosity, and thus the first and second resins may exhibit an effect of selectively coating a surface of a pellet or a molded article without using a separate additional process. Therefore, the present application has been completed from the results.

Especially, the second resin contains a certain organic functional group, for example an organic functional group having one or more oxygen atoms to exhibit high cross-linking characteristics, and has a lower melt viscosity than the first resin. Therefore, the layer separation may occur in a process such as extrusion or injection.

For example, the second resin may be positioned or distributed at a position at which the second resin comes in contact with the air so as to form a surface layer of the pellet or the molded article, and may also significantly improve surface hardness since the second resin has a very high glass transition temperature. As a result, when the resin blend for a melting process is used, a resin-molded article having excellent mechanical properties and high surface hardness may be obtained without applying an additional coating process.

According to one exemplary embodiment of the present application, resin blend for a melting process including a first resin and a second resin may be provided. Here, the second resin includes a polymer resin having an organic functional group containing one or more oxygen atoms, and has a melt viscosity difference of 0.1 to 3,000 pa*s with respect to the first resin at a shear rate of 100 to 1,000 s⁻¹ and a processing temperature of the resin blend.

The melt viscosity difference between the first resin and the second resin at the shear rate of 100 to 1,000 s⁻¹ and the processing temperature of the resin blend may be in a range of 0.1 to 3,000 pa*s, 1 to 2,000 pa*s, or 1 to 1,000 pa*s. The melt viscosity difference may appear when a bulky and cross-linkable functional group is added to a side chain. When the melt viscosity difference is very small, the first resin is easily miscible with the second resin, which makes it difficult to facilitate the layer separation. On the other hand, when the melt viscosity difference is very high, the first resin may be peeled from the second resin without binding to the second resin.

The melt viscosity may be measured using capillary flow, and refers to a shear viscosity (pa*s) according to a certain processing temperature and shear rate (/s).

The ‘shear rate’ refers to a shear rate applied when processing the resin blend. As a result, the shear rate may be adjusted according to a processing method.

The ‘processing temperature’ refers to a temperature at which the resin blend is processed. For example, when the resin blend is subjected to melt processing such as extrusion or injection, the processing temperature means a temperature applied in the melt processing process. The processing temperature may be adjusted according to the kind of resins subjected to the melt processing such as extrusion or injection. For example, a resin blend including a first resin of an acrylonitrile butadiene styrene (ABS) resin and a second resin obtained from a methyl methacrylate-based monomer may have a processing temperature of 210 to 240° C.

Also, a glass transition temperature difference between the first resin and the second resin may be 10° C. or more, or 30° C. or more. When the glass transition temperature difference between the first resin and the second resin is greater than or equal to 10° C., the layer separation may appear more easily in a process such as extrusion or injection while varying physical properties or fluidity of both the first and second resins. In particular, when the second resin has a glass transition temperature 10° C. higher than the first resin, the second resin having a higher glass transition temperature may be positioned at an outer part of a resin-molded article, thereby significantly improving surface hardness. An upper limit of the glass transition temperature is not particularly limited, but may be less than or equal to 150° C.

Meanwhile, the first resin is a resin which mainly determines physical properties of a desired molded article, and may be selected according to the kinds of the desired molded article and process conditions used. A typical synthetic resin may be used as the first resin without limitation. Preferably, the first resin may include a styrene-based resin such as an ABS-based resin, a polystyrene-based resin, an acrylonitrile styrene acrylate (ASA)-based resin or a styrene-butadiene-styrene block copolymer-based resin; a polyolefin-based resin such as a high-density polyethylene-based resin, a low-density polyethylene-based resin or a polypropylene-based resin; a thermoplastic elastomer such as an ester-based thermoplastic elastomer or an olefin-based thermoplastic elastomer; a polyoxyalkylene-based resin such as a polyoxymethylene-based resin or a polyoxyethylene-based resin; a polyester-based resin such as a polyethylene terephthalate-based resin or a polybutylene terephthalate-based resin; a polyvinyl chloride-based resin; a polycarbonate-based resin; a polyphenylene sulfide-based resin; a vinyl alcohol-based resin; a polyamide-based resin; an acrylate-based resin; an engineering plastic; and a copolymer or a blend thereof.

The second resin refers to a resin which exhibits a difference in physical properties with respect to the first resin as described above, and provides a surface of a desired molded article with excellent mechanical properties and high surface hardness. In particular, the second resin may include a polymer resin which has a volume greater than or equal to a predetermined size and contains a cross-linkable organic functional group. As the certain organic functional group is introduced, the polymer resin may have a lower melt viscosity. Therefore, the polymer resin having the specific organic functional group may move a surface of the resin blend, which may easily come in contact with the air in the resin blend, and thus the above-described layer separation may occur more easily in the process such as extrusion or injection. In addition, as the specific organic functional group is introduced, the second resin may have a high glass transition temperature due to a cross-linking reaction in the melt processing process such as extrusion or injection. As a result, surface hardness of a final molded article may be further enhanced.

The organic functional group, which is cross-linkable and has a volume greater than or equal to a predetermined size, may be an organic functional group containing one or more oxygen atoms. Specific examples of the organic functional group may include a functional group represented by the following Formula 1.

Formula 1

—R₁—Cy₁

In Formula 1,R₁ represents a single bond or an alkylene group having 1 to 16 carbon atoms, and Cy₁ represents an oxacycloalkyl group having 2 to 40 carbon atoms.

In Formula 1, R₁ may be a single bond or an alkylene group having 1 to 8 carbon atoms. For example, R₁ may be a single bond or an alkylene group having 1 to 4 carbon atoms.

In Formula 1, Cy₁ may also be an oxacycloalkyl group having 2 to 20 carbon atoms, or an oxacycloalkyl group having 2 to 10 carbon atoms.

In this case, specific examples of the functional group represented by Formula 1 may include a glycidyl group, 2-ethyl-oxacyclobutyl group, or tetrahydrofurfuryl group.

Also, specific kinds of the polymer resin which may be included in the second resin are not particularly limited, but may include a (meth)acrylate-based resin, an epoxy-based resin, an oxetane-based resin, an isocyanate-based resin, a silicone-based resin, a fluorine-based resin and a copolymer thereof.

The (meth)acrylate-based resin is a polymer including an acrylic or methacrylic monomer as a main component. For example, in addition to a methacrylate and an acrylate, the (meth)acrylate-based resin may include an alkyl methacrylate such as methyl methacrylate, ethyl methacrylate, propyl methacrylate, butyl methacrylate, cyclohexyl methacrylate, octyl methacrylate, lauryl methacrylate or stearyl methacrylate; an alkylacrylate such as methylacrylate, ethylacrylate, propylacrylate, butylacrylate, octylacrylate, laurylacrylate or stearylacrylate; or a glycidyl (meth)acrylate such as glycidyl methacrylate or glycidylacrylate, but the present application is not limited thereto.

The epoxy-based resin has an epoxy group introduced therein, and may, for example, include a bisphenol-type resin such as a bisphenol A-type resin, a bisphenol F-type resin, a bisphenol S-type resin and a hydrate thereof; a novolac-type resin such as a phenol novolac-type resin or a cresol novolac-type resin; a nitrogen-containing ring-type resin such as a triglycidylisocyanurate-type resin or a hydantoin-type resin; an alicyclic resin; an aliphatic resin; an aromatic resin such as a naphthalene-type resin or a biphenyl-type resin; a glycidyl-type resin such as a glycidylether-type resin, glycidylamine-type resin or a glycidylester-type resin; a dicyclo-type resin such as a dicyclopentadiene-type resin; an ester-type resin; or an etherester-type resin, but the present application is not limited thereto.

The oxetane-based resin is an organic compound which is formed by polymerization of an oxetane monomer containing one or more oxetane rings. For example, the oxetane-based resin may include a polyoxetane compound such as 1,4-bis [(3-ethyl-3-oxetanylmethoxy)methyl]benzene, di[1-ethyl(3-oxetanyl)]methylether, phenol novolac oxetane, terephthalate bisoxetane, or biphenylene bisoxetane, but the present application is not limited thereto.

The isocyanate-based resin is a resin containing an isocyanate group. For example, the isocyanate-based resin may include diphenylmethane diisocyanate (MDI), toluene diisocyanate (TDI), or isophorone diisocyanate (IPDI), but the present application is not limited thereto.

The silicone-based resin has a main chain formed through a siloxane bond which is a silicon-oxygen bond. For example, the silicone-based resin may include polydimethylsiloxane (PDMS), but the present application is not limited thereto.

The fluorine-based resin has a fluorine atom introduced therein. For example, the fluorine-based resin may include polytetrafluoroethylene (PTFE), polychlorotrifluoroethylene (PCTFE), polyvinylidene fluoride (PVDF), or polyvinyl fluoride (PVF), but the present application is not limited thereto.

The resin blend for a melting process may include the second resin at a content of 0.1 to 50 parts by weight, or 1 to 20 parts by weight, based on 100 parts by weight of the first resin.

When the second resin is included at a content less than 0.1 parts by weight, based 100 parts by weight of the first resin, the layer separation does not occur, whereas an increase in production cost may be caused when the second resin is included at a content greater than 50 parts by weight.

The resin blend for a melting process may be prepared into a pellet using a process such as extrusion. The pellet prepared using the resin blend for a melting process may have a structure in which the first resin is disposed at a central portion thereof and the second resin is layer-separated from the first resin to be disposed at a surface thereof.

According to one exemplary embodiment of the present application, a pellet including a core including a first resin and a shell including a second resin may be provided. Here, the second resin includes a polymer resin having an organic functional group containing one or more oxygen atoms, and has a melt viscosity difference of 0.1 to 3,000 pa*s with respect to the first resin at a shear rate of 100 to 1,000 s⁻¹ and a processing temperature of the pellet.

As described above, a glass transition temperature difference between the first resin and the second resin may also be in a range of 10° C. to 150° C., or 30° C. to 150° C.

The details regarding the kinds and physical properties of the first resin and the second resin have been specifically disclosed, and thus are omitted for clarity.

Meanwhile, according to another exemplary embodiment of the present application, a method of preparing a resin-molded article, which includes melt-processing the resin blend for a melting process, may be provided.

As described above, since the second resin has a lower melt viscosity than the first resin, layer separation may occur during extrusion or injection of the resin blend. As a result, the layer separation may result in an effect of selectively coating a surface of a pellet or a molded article without performing a separate additional process.

In particular, since the second resin according to one exemplary embodiment of the present application may have a lower melt viscosity and a higher glass transition temperature when the above organic functional group is introduced into the second resin, the second resin may more easily move to a surface of an molded article coming in contact with the air, and the layer separation may occur more easily during a process such as extrusion or injection. As a result, since a high-hardness resin having a relatively high glass transition temperature is disposed at a surface of the molded article, the molded article having improved mechanical properties and surface characteristics may be provided.

Also, the melt processing may be performed under a shear stress. For example, the melt processing may include injection and extrusion, but the present application is not limited thereto.

The resin blend for a melting process may be prepared into a pellet using a melt processing process such as extrusion. Also, the resin blend may be prepared into a pellet through extrusion, and the pellet may be then prepared into a molded article through a melt processing process such as injection. In addition, the resin blend may be prepared into a molded article through direct injection.

The temperature may vary according to the kinds of the first and second resins used in the process of extruding or injecting the resin blend.

Also, the method of preparing a resin-molded article may further include curing a product obtained by melt-processing the resin blend, that is, a melt-processed article of the resin blend.

Meanwhile, the method of preparing a resin-molded article may further include forming a second resin before melt-processing the resin blend for a melting process. In the forming of the second resin, a method such as bulk polymerization, solution polymerization, suspension polymerization or emulsion polymerization may be used.

The forming of the second resin may include dispersing a polymer resin, which has an organic functional group containing one or more oxygen atoms, in a reaction solvent; adding at least one additive selected from the group consisting of a chain transfer agent, an initiator and a dispersion stabilizer to the reaction solvent and mixing the additive with the reaction solvent; and reacting the resulting blend at a temperature of 40° C. or more (polymerization step).

The reaction solvent may be used without limitation as long as it is generally known to be able to be used to prepare a synthetic resin, a polymer or a copolymer. Examples of such a reaction solvent may include methyl isobutyl ketone, distilled water and the like.

As the chain transfer agent which may be added to the reaction solvent, an alkyl mercaptan such as n-butyl mercaptan, n-dodecyl mercaptan, tert-dodecylmercaptan, isopropyl mercaptan or n-aryl mercaptan; a halogen compound such as carbon tetra chloride; or an aromatic compound such as an a-methylstyrene dimer or an α-ethylstyrene dimer may be used, but the present application is not limited thereto.

As the initiator, a polymerization initiator generally known to be able to be used in suspension polymerization, for example, a peroxide such as octanoyl peroxide, decanoyl peroxide or lauroyl peroxide or an azo-based compound such as azobisisobutyronitrile or azobis-(2,4-dimethyl)-valeronitrile may be used without particular limitation.

Examples of the dispersion stabilizer which may be included in the reaction solvent may include an organic dispersing agent such as polyvinyl alcohol, polyolefin-maleic acid, or cellulose, or an inorganic dispersing agent such as tricalcium phosphate, but the present application is not limited thereto.

The details of the first resin, the second resin and the organic functional group containing one or more oxygen atoms have been described above, and thus detailed description thereof is omitted for clarity.

Meanwhile, according to still another exemplary embodiment of the present application, a melt-processed resin-molded article including a first resin layer, a second resin layer formed on the first resin layer, and an interfacial layer which is formed between the first resin layer and the second resin layer and which includes a first resin and a second resin may be provided. Here, the second resin layer includes a polymer resin having an organic functional group containing one or more oxygen atoms.

The resin-molded article, which is prepared from a resin blend including a first resin and a second resin including the above-described polymer resin having an organic functional group, may have a layer separation structure in which a first resin layer is disposed at an inner part thereof and a second resin layer is formed on a surface thereof.

The melt viscosity difference or glass transition temperature difference may facilitate layer separation of the first resin and the second resin may during a process such as extrusion or injection and movement of the second resin to the surface of the resin-molded article. As a result, the resin-molded article having a structure in which the first resin layer is disposed at an inner part thereof and the second resin layer is disposed on a surface thereof may be provided. Such a resin-molded article may realize improved mechanical properties and high surface hardness, thereby eliminating a coating or painting process to improve surface characteristics, reducing a processing time for production and the production cost and enhancing productivity of a final product.

The structure of the resin-molded article, that is, a structure in which the first resin layer and the second resin layer are divided by the interfacial layer and the second resin layer is exposed to external environments, is not known in the related art but is deemed to have novelty. When a typical resin is subjected to injection or extrusion, it is impossible to form such a structure, and it is also difficult to realize the effects according to the structure.

In particular, since the second resin includes the above-described polymer resin having a certain organic functional group, the second resin may have a lower melt viscosity. Therefore, the second resin may move more easily to a surface of the resin-molded article coming in contact with the air, and the layer separation may occur more easily during a process such as extrusion or injection. Also, the introduction of the certain organic functional group may further enhance the surface hardness of the resin-molded article.

The ‘first resin layer’ refers to an inner region of a resin-molded article which predominantly includes the first resin. Also, the ‘second resin layer’ refers to an outer region of the resin-molded article which predominantly includes the second resin and endows a surface of the molded article with some functions.

The details of the polymer including the first resin, the second resin and the certain organic functional group included in the second resin have been described above, and thus detailed description thereof is omitted for clarity.

Meanwhile, the resin-molded article may include an interfacial layer which is formed between the first resin layer and the second resin layer and includes a resin blend of first and second resins. The interfacial layer formed between the layer-separated first resin layer and the second resin layer may serve as a boundary, and may include the resin blend of first and second resins. In the resin blend, the first resin and the second resin may be physically or chemically bound to each other. Also, the first resin layer may be bound to second resin layer via the resin blend.

As described above, the resin-molded article may have a structure in which the first resin layer and the second resin layer are divided by the interfacial layer and the second resin layer are exposed to external environments. For example, the molded article may have a structure in which the first resin layer, the interfacial layer and the second resin layer are sequentially stacked in this sequence, or in which an interface and a second resin are stacked at upper and lower ends of the first resin. Also, the resin-molded article may have a structure in which the interface and the second resin layer sequentially surround the first resin layer having various 3D shapes, for example spherical, round, polyhedral and sheet-type shapes.

The layer separation observed in the melt-processed resin-molded article seems to occur when certain first and second resins having different physical properties are used to prepare a melt-processed resin-molded article. Examples of the different physical properties may include melt viscosity. The details of the difference in physical properties are as described above.

Meanwhile, the first resin layer, the second resin layer and the interfacial layer may be confirmed using a scanning electron microscope (SEM) by subjecting each test sample to a low-temperature impact test, followed by etching a fracture surface of the test sample with THF vapor. Also, the thickness of each layer may be measured by cutting a test sample using a diamond blade of microtoming equipment, making a cut section smooth and etching the smooth section with a solution which may be prepared to relatively more easily dissolve the second resin than the first resin. Different portions of the smooth section may be etched to different extents according to the contents of the first resin and the second resin, and the first resin layer, the second resin layer, the interfacial layer and a surface of the test sample may be observed by a shade difference, as viewed from a surface of the test sample at an angle of 45° using an SEM. Then, the thickness of each layer may be measured based on these facts. In the present application, a 1,2-dichloroethane solution (10% by volume in EtOH) is used as the solution prepared to relatively more easily dissolve the second resin, but this is described for purposes of illustration only. Therefore, solutions in which the second resin has higher solubility than the first resin are not particularly limited, and may be altered according to the kind and compositions of the second resin.

The interfacial layer may have a thickness of 0.01 to 95%, or 0.1 to 70%, based on the sum of thicknesses of the second resin layer and the interfacial layer. When the interfacial layer has a thickness of 0.01 to 95% based on the sum of thicknesses of the second resin layer and the interfacial layer, peeling between the first resin layer and the second resin layer does not take place due to excellent interfacial bond strength between the first resin layer and the second resin layer, and surface characteristics may be drastically improved due to the presence of the second resin layer. On the other hand, when the interfacial layer is much smaller in thickness than the second resin layer, peeling between the first resin layer and the second resin layer may take place due to low bond strength between the first resin layer and the second resin layer, whereas the surface characteristics may be slightly improved by the presence of the second resin layer when the interfacial layer is much higher in thickness than the second resin layer.

The second resin may have a thickness of 0.01 to 60%, or 1 to 40%, based on a total thickness of the resin-molded article. When the second resin has a thickness within a predetermined thickness range, a surface of a molded article may be endowed with improved surface hardness or scratch resistance. When the second resin has a very small thickness, it is difficult to sufficiently improve surface characteristics of the molded article. On the other hand, when the second resin has a very high thickness, mechanical properties of a functional resin itself may be reflected in the resin-molded article to alter mechanical properties of the first resin.

The details of the first resin, the second resin, the difference in physical properties between the first resin and the second resin, and the polymer having a certain organic functional group included in the second resin have been described above, and thus detailed description thereof is omitted for clarity.

Meanwhile, according to still another exemplary embodiment of the present application, a melt-processed resin-molded article including a first resin layer and a second resin layer formed on the first resin layer may be provided. Here, components of the first resin layer on a surface of the second resin layer are detected by means of an infrared (IR) spectrometer, and the second resin layer includes a polymer resin having an organic functional group containing one or more oxygen atoms.

The structure of the molded article, that is, a structure in which the components of the first resin layer on the surface of the second resin layer are detected by means of the IR spectrometer, is not known in the related art but is deemed to have novelty. In the coating process, it is generally difficult to detect the components of the first resin layer on the surface of the second resin layer.

As such, the surface of the second resin layer means a surface which does not face the first resin layer but is exposed to external environments.

The details of the first resin, the second resin, the difference in physical properties between the first resin and the second resin, and the polymer having a certain organic functional group included in the second resin have been described above, and thus detailed description thereof is omitted for clarity.

Also, in this specification, the difference in physical properties may refer to a difference in physical properties between the first resin and the second resin, or a difference in physical properties between the first resin layer and the second resin layer.

Furthermore, according to yet another exemplary embodiment of the present application, parts of an automobile, helmets, parts of electronic equipment, parts of a spinning machine, toys and pipes, all of which include the melt-processed resin-molded article, may be provided.

According to the present application, a resin blend for a melting process capable of improving mechanical properties and surface hardness of a molded article and also exhibiting effects of reducing a processing time, enhancing productivity and cutting the production cost by eliminating an additional surface coating step, a pellet, a method of preparing a resin-molded article using the same, and a resin-molded article can be provided.

### BRIEF DESCRIPTION OF THE DRAWINGS

The above and other objects, features and advantages of the present application will become more apparent to those of ordinary skill in the art by describing in detail exemplary embodiments thereof with reference to the attached drawings, in which:

FIG. 1 is an SEM image showing a layer-separated cross-section of a molded article prepared in Example 2; and

FIG. 2 is an SEM image showing a layer-separated cross-section of a molded article prepared in Comparative Example 1.

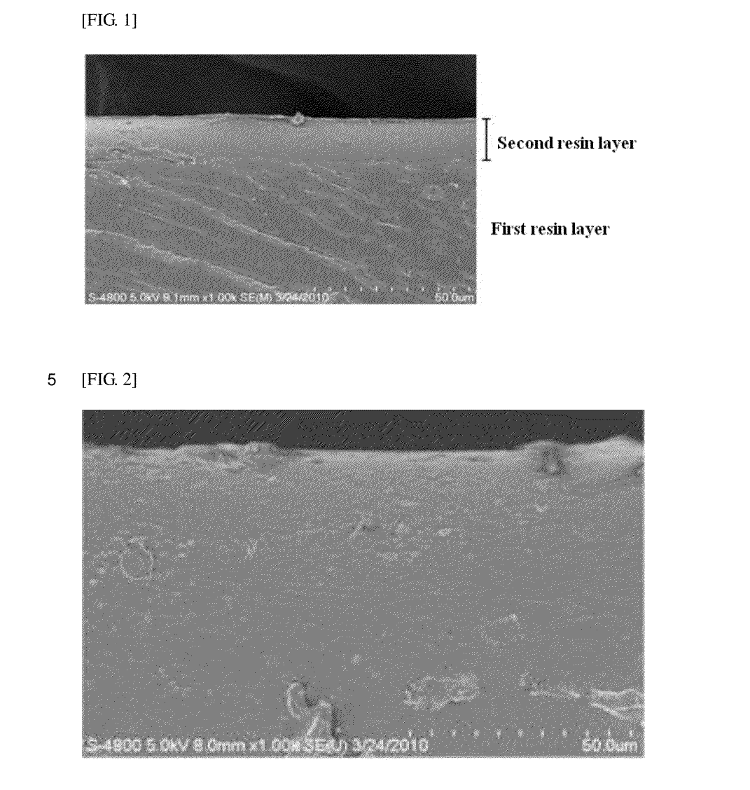

### DETAILED DESCRIPTION OF EXEMPLARY EMBODIMENTS

Hereinafter, exemplary embodiments of the present application will be described in detail. However, the present application is not limited to the embodiments disclosed below, but can be implemented in various forms. The following embodiments are described in order to enable those of ordinary skill in the art to embody and practice the present application.

### EXPERIMENTAL EXAMPLE 1

### Measurement of Glass Transition Temperature

Glass transition temperatures of first resins and second resins used in Examples and Comparative Examples were measured using a differential scanning calorimeter (DSC823e commercially available from Mettler-toledo). More particularly, an aluminum fan containing 1 mg of a sample of a first resin or a second resin was installed in a measuring instrument, and a glass transition temperature of the sample was measured at a temperature of −50 to 300° C. (at a rate of 10° C./min: 2 cycles).

The glass transition temperature of the first resin used in the present application was 70° C., and the glass transition temperature of the second resin used in each of Examples and Comparative Examples was measured to calculate a glass transition temperature difference between the first resin and the second resin.

### EXPERIMENTAL EXAMPLE 2

### Measurement of Melt Viscosity

Melt viscosities of the first resin, the second resin and the test sample obtained in Examples and Comparative Examples were measured using a capillary rheometer (Capillary Rheometer 1501 commercially available from Gottfert).

More particularly, a capillary die was attached to a barrel, and the second resin, the first resin or the test sample was put into the barrel at three divided doses. Thereafter, the shear viscosity (pa*s) of the second resin, the first resin or the test sample was measured at a processing temperature of 240° C. and a shear rate of 100 to 1,000 s⁻¹.

### EXPERIMENTAL EXAMPLE 3

### Observation of Cross-Section Shape

The test samples prepared in Examples and Comparative Examples were subjected to a low-temperature impact test, and fracture surfaces of the test samples were etched with THF vapor, and layer-separated cross-section shapes of the test samples were observed using an SEM.

Meanwhile, to measure thicknesses of the layer-separated first resin layer, second resin layer and interfacial layer, the cross-sections of the test samples prepared in the following Examples and Comparative Examples were cut at a temperature of −120° C. using a diamond blade of a microtoming equipment (Leica EM FC6), and made smooth. The microtomed smooth cross-sections of the test samples were dipped in a 1,2-dichloroethane solution (10% in EtOH), etched for 10 seconds, and then washed with distilled water. The different portions of the cross-sections were etched to different extents according to the contents of the first resin and the second resin, and observed using an SEM. That is, the first resin layer, the second resin layer and the interfacial layer may be observed by a shade difference, as viewed from a surface of the test sample at an angle of 45°. Then, the thickness of each layer may be measured using the results.

### EXPERIMENTAL EXAMPLE 4

### Experiment for Measuring Impact Strength

Impact strengths of the test samples prepared in Examples and Comparative Examples were measured according to the ASTM D256 standard. More particularly, an energy (Kg*cm/cm) required to destroy a test sample having a V-shaped notch when a weight hung on the end of a pendulum was dropped on the test sample was measured using an impact tester (Impact 104 commercially available from Tinius Olsen). The ⅛″ and ¼″ test samples were measured five times to calculate average energy values.

### EXPERIMENTAL EXAMPLE 5

### Experiment for Measuring Pencil Hardness

Surface pencil hardness of the test samples prepared in Examples and Comparative Examples was measured under a constant load of 500 g using a pencil durometer (commercially available from ChungbukTech). Scratches are applied to a reference pencil (commercially available from Mitsubishi) at a constant angel of 45° while altering the pencil hardness from 6B to 9H, and a surface change of the pencil was observed (ASTM 3363-74). The pencil hardness of the test sample was calculated as an average value of the experiments which were performed 5 times.

### EXPERIMENTAL EXAMPLE 6

### Surface Analysis Using Infrared Spectrometer (IRS)

An UMA-600 infrared microscope equipped with a Varian FTS-7,000 spectroscope (Varian, USA) and a mercury cadmium telluride (MCT) detector was used, and spectrum measurement and data processing were performed using Win-IR PRO 3.4 software (Varian, USA). The measurement conditions are described as follows.

Germanium (Ge) attenuated total reflection (ATR) crystals having a refractive index of 4.0.

Mid-infrared spectra are scanned 16 times using an ATR method with a spectral resolution of 8 cm⁻¹ at wavelengths spanning from 4,000 cm⁻¹ to 600 cm⁻¹.

Internal reference band: carbonyl group of acrylate (C═O str., approximately 1,725 cm⁻¹).

Innate component of first resin: butadiene compound [C═C str. (approximately 1,630 cm⁻¹) or ═C—H out-of-plane vib. (approximately 970 cm⁻¹)].

Peak intensity ratios [I_{BD}(C═C)/I_{A}(C═O)] and [I_{BD}(out-of-plane)/I_{A}(C═O)] were calculated, and spectrum measurements were performed five times on different regions in one sample to calculate an average value and a standard deviation.

### EXAMPLE 1

(1) Preparation of second resin

1,500 g of distilled water and 4 g of an aqueous solution including a dispersing agent (2% polyvinyl alcohol) were put into a 3 L reactor, and dissolved. Thereafter, 560 g of methyl methacrylate (MMA), 240 g of glycidyl methacrylate (GMA), 2.4 g of n-dodecylmercaptan (n-DDM) as a chain transfer agent, and 2.4 g of azodiisobutyronitrile (AIBN) as an initiator, were further added into the reactor (3L), and mixed while stirring at 400 rpm. The resulting blend was reacted at 60° C. for 3 hours to perform polymerization, and cooled to 30° C. to obtain a second resin in the form of beads. Then, the second resin was washed three times with distilled water, dehydrated, and dried in an oven.

(2) Preparation of resin blend and molded article using the resin blend

7 parts by weight of the second resin was mixed with 93 parts by weight of the first resin (a thermoplastic resin including methyl methacrylate at 60% by weight, acrylonitrile at 7% by weight, butadiene at 10% by weight, and styrene at 23% by weight), and the resulting blend was extruded at a temperature of 240° C. in a twin screw extruder (commercially available from Leistritz) to obtain a pellet.

Thereafter, the pellet was injected at a temperature of 240° C. in an EC100030 injector (commercially available from ENGEL) to prepare a test sample of a resin-molded article having a thickness of 3,200 nm.

(3) Measurement of physical properties of test sample

The physical properties of the test sample prepared as described above were measured. As a result, the second resin layer had a thickness of 82 nm, the interfacial layer had a thickness of 33 nm, the melt viscosity difference was 180 pa*s, the second resin had a glass transition temperature (T_{g}) of 180° C., the impact strengths were 3.2 kg·cm/cm in case of IZOD ⅛″ and 5.1 kg·cm/cm in case of IZOD 1/4″, the pencil hardness was 2H, and the layer separation took place.

The peak intensity ratio [I_{BD}(C═C)/I_{A}(C═O)] measured by the infrared spectrometer was 0.0124 on the average with a standard deviation of 0.0006, and the peak intensity ratio [I_{BD}(out-of-plane)/I_{A}(C═O)] was 0.411 on the average with a standard deviation of 0.0022.

### EXAMPLE 2

A test sample having a thickness of 3,200 nm was prepared in the same manner as in Examplel, except that 560 g of methyl methacrylate and 240 g of 3-ethyl-3-methacryloyloxy methyloxetane (EMO) were used as monomers instead of 560 g of methyl methacrylate (MMA) and 240 g of glycidyl methacrylate (GMA).

The physical properties of the test sample prepared as described above were measured. As a result, the second resin layer had a thickness of 80 nm, the interfacial layer had a thickness of 30 nm, the melt viscosity difference was 280 pa*s, the second resin had a glass transition temperature (T_{g}) of 101° C., the impact strengths were 8.5 kg·cm/cm in case of IZOD ⅛″ and 8.9 kg·cm/cm in case of IZOD ¼″, the pencil hardness was 2H, and the layer separation took place.

### EXAMPLE 3

A test sample having a thickness of 3,200 nm was prepared in the same manner as in Examplel, except that 400 g of methyl methacrylate and 400 g of 3-ethyl-3-methacryloyloxy methyloxetane (EMO) were used as monomers instead of 560 g of methyl methacrylate (MMA) and 240 g of glycidyl methacrylate (GMA).

The physical properties of the test sample prepared as described above were measured. As a result, the second resin layer had a thickness of 83 nm, the interfacial layer had a thickness of 26 nm, the melt viscosity difference was 370 pa*s, the second resin had a glass transition temperature (T_{g}) of 102° C., the impact strengths were 7.7 kg·cm/cm in case of IZOD ⅛″ and 6.8 kg·cm/cm in case of IZOD ¼″, the pencil hardness was 2.5 H, and the layer separation took place.

### EXAMPLE 4

A test sample having a thickness of 3,200 nm was prepared in the same manner as in Examplel, except that 240 g of methyl methacrylate and 560 g of 3-ethyl-3-methacryloyloxy methyloxetane (EMO) were used as monomers instead of 560 g of methyl methacrylate (MMA) and 240 g of glycidyl methacrylate (GMA).

The physical properties of the test sample prepared as described above were measured. As a result, the second resin layer had a thickness of 89 nm, the interfacial layer had a thickness of 24 nm, the melt viscosity difference was 490 pa*s, the second resin had a glass transition temperature (T_{g}) of 105° C., the impact strengths were 3.9 kg·cm/cm in case of IZOD ⅛″ and 4.3 kg·cm/cm in case of IZOD ¼″, the pencil hardness was 3 H, and the layer separation took place.

### EXAMPLE 5

(1) Preparation of second resin

A second resin was obtained in the same manner as in Example 2.

(2) Preparation of resin blend and molded article using the resin blend

21 parts by weight of the second resin was mixed with 79 parts by weight of the first resin, and a test sample having a thickness of 3,200 nm was prepared in the same manner as in Example 1.

(3) Measurement of physical properties of test sample

The physical properties of the test sample prepared as described above were measured. As a result, the second resin layer had a thickness of 96 nm, the interfacial layer had a thickness of 52 nm, the melt viscosity difference was 280 pa*s, the second resin had a glass transition temperature (T_{g}) of 101° C., the impact strengths were 4.2 kg·cm/cm in case of IZOD ⅛″ and 3.9 kg·cm/cm in case of IZOD ¼″, the pencil hardness was 3 H, and the layer separation took place.

### EXAMPLE 6

A test sample having a thickness of 3,200 nm was prepared in the same manner as in Example 1, except that 560 g of methyl methacrylate (MMA), 240 g of 3-ethyl-3-methacryloyloxy methyloxetane, 1.6 g of a chain transfer agent, n-dodecylmercaptan, and 2.4 g of an initiator, azodiisobutyronitrile (AIBN), were put into the 3 L reactor.

The physical properties of the test sample prepared as described above were measured. As a result, the second resin layer had a thickness of 84 μm, the interfacial layer had a thickness of 33 μm, the melt viscosity difference was 470 pa*s, the second resin had a glass transition temperature (T_{g}) of 100° C., the impact strengths were 5.3 kg·cm/cm in case of IZOD ⅛″ and 5.8 kg·cm/cm in case of IZOD ¼″, the pencil hardness was 2.5 l H, and the layer separation took place.

### COMPARATIVE EXAMPLE 1

100 parts by weight of a pellet formed of a first resin (a thermoplastic resin including methyl methacrylate at 60% by weight, acrylonitrile at 7% by weight, butadiene at 10% by weight, and styrene at 23% by weight was dried in an oven, and injected at a temperature of 240° C. in an EC100030 injector (commercially available from ENGEL) to prepare a test sample having a thickness of 3,200 μm.

The physical properties of the test sample prepared as described above were measured. As a result, the test sample had a glass transition temperature (T_{g}) of 70° C., impact strengths of 9.9 kg·cm/cm in case of IZOD ⅛″ and 10.0 kg·cm/cm in case of IZOD ¼″, and a pencil hardness of F.

### COMPARATIVE EXAMPLE 2

A test sample having a thickness of 3,200 μm was prepared in the same manner as in Example 1, except that 560 g of methyl methacrylate (MMA), 240 g of 3-ethyl-3-methacryloyloxy methyloxetane, 1.6 g of a chain transfer agent, n-dodecylmercaptan, and 0.8 g of an initiator, azodiisobutyronitrile (AIBN), were put into the 3 L reactor.

The physical properties of the test sample prepared as described above were measured. As a result, the second resin layer had a thickness of 2 nm, the thickness of the interfacial layer was not measurable, the melt viscosity difference was 1,090 pa*s, the second resin had a glass transition temperature (T_{g}) of 102° C., the impact strengths were 8.7 kg·cm/cm in case of IZOD ⅛″ and 9.2 kg·cm/cm in case of IZOD ¼″, the pencil hardness was H, and the layer separation hardly took place.

### COMPARATIVE EXAMPLE 3

A test sample having a thickness of 3,200 nm was prepared in the same manner as in Example 1, except that 560 g of methyl methacrylate and 240 g of normal hexyl methacrylate were used as monomers instead of 560 g of methyl methacrylate and 240 g of glycidyl methacrylate.

The physical properties of the test sample prepared as described above were measured. As a result, the second resin layer had a thickness of 81 nm, the interfacial layer had a thickness of 17 nm, the melt viscosity difference was 460 pa*s, the second resin had a glass transition temperature (T_{g}) of 62° C., the impact strengths were 9.5 kg·cm/cm in case of IZOD ⅛″ and 9.3 kg·cm/cm in case of IZOD ¼″, the pencil hardness was HB, and the layer separation took place.

### COMPARATIVE EXAMPLE 4

100 parts by weight of a pellet formed of a first resin (a thermoplastic resin including methyl methacrylate at 60% by weight, acrylonitrile at 7% by weight, butadiene at 10% by weight, and styrene at 23% by weight was dried in an oven, and injected at a temperature of 240° C. in an EC100030 injector (commercially available from ENGEL) to prepare a test sample.

The test sample was coated with an anti-pollution hard coating solution (including DPHA at 17.5% by weight, PETA at 10% by weight, perfluorohexylethyl methacrylate at 1.5% by weight, an urethane acrylate (EB 1290 commercially available from SK Cytech) at 5% by weight, methyl ethyl ketone at 45% by weight, isopropyl alcohol at 20% by weight, and a UV initiator (IRGACURE 184 commercially available from Ciba) at 1% by weight), which was prepared by the present inventors to include a multifunctional acrylate, using Mayer bar #9, and dried at a temperature of 60 to 90° C. for approximately 4 minutes to form a film. Then, the coating composition was cured by irradiation with UV rays at an intensity of 3,000 mJ/cm² to form a hard coating film.

The hard coating film had a pencil hardness of 3 H, and both the peak intensity ratios [I_{BD}(C═C)/I_{A}(C═O)] and [I_{BD}(out-of-plane)/I_{A}(C═O)] measured by the infrared spectrometer were 0 on the average with a standard deviation of 0.

As described above, it was confirmed that, when the resin blends prepared in Examples were used, the layer separation between the resin layers took place during processes such as extrusion and injection, and the high-hardness resin was distributed on a surface of the resin-molded article due to such layer separation, thereby making it possible to exhibit excellent surface hardness without performing an additional coating or painting process.

On the other hand, it was confirmed that the resin-molded articles prepared in Comparative Examples had relatively low surface hardness, and thus could not be generally used for electronic products, parts of an automobile and the like without performing an additional coating or painting process.

What is claimed is:

1. A resin blend for a melting process comprising a first resin and a second resin,
wherein the second resin comprises a polymer resin having an organic functional group containing one or more oxygen atoms, and has a melt viscosity difference of 0.1 to 3,000 pa*s with respect to the first resin at a shear rate of 100 to 1,000 s⁻¹ and a processing temperature of the resin blend.

2. The resin blend of claim 1, wherein the melt viscosity difference between the first resin and the second resin at the shear rate of 100 to 1,000 s⁻¹ and the processing temperature of the resin blend is in a range of 0.1 to 2,000 pa*s.

3. The resin blend of claim 1, wherein a glass transition temperature difference between the first resin and the second resin is in a range of 10° C. to 150° C.

4. The resin blend of claim 1, wherein the glass transition temperature difference between the first resin and the second resin is in a range of 30° C. to 150° C.

5. The resin blend of claim 1, wherein the organic functional group containing one or more oxygen atoms comprises a functional group represented by the following Formula 1:
Formula 1
—R₁—Cy₁
wherein R₁ represents a single bond or an alkylene group having 1 to 16 carbon atoms, and Cy₁ represents an oxacycloalkyl group having 2 to 40 carbon atoms.

6. The resin blend of claim 1, wherein the first resin comprises at least one selected from the group consisting of a styrene-based resin, a polyolefin-based resin, a thermoplastic elastomer, a polyoxyalkylene-based resin, a polyester-based resin, a polyvinyl chloride-based resin, a polycarbonate-based resin, a polyphenylene sulfide-based resin, a vinyl alcohol-based resin, an acrylate-based resin, an engineering plastic, and a copolymer thereof.

7. The resin blend of claim 1, wherein the polymer resin included in the second resin comprises at least one selected from the group consisting of a (meth)acrylate-based resin, an epoxy-based resin, an oxetane-based resin, an isocyanate-based resin, a silicone-based resin, a fluorine-based resin, and a copolymer thereof.

8. A pellet comprising a core including a first resin and a shell including a second resin,
wherein the second resin comprises a polymer resin having an organic functional group containing one or more oxygen atoms, and has a melt viscosity difference of 0.1 to 3,000 pa*s with respect to the first resin at a shear rate of 100 to 1,000 s⁻¹ and a processing temperature of the resin blend.

9. The pellet of claim 8, wherein a glass transition temperature difference between the first resin and the second resin is in a range of 10° C. to 150° C.

10. A method of preparing a resin-molded article, comprising:
melt-processing the resin blend defined in claim 1.

11. The method of claim 10, further comprising:
curing a melt-processed article of the resin blend.

12. A method of preparing a resin-molded article, comprising:
melt-processing the pellet defined in claim 8.

13. A melt-processed resin-molded article comprising:
a first resin layer;
a second resin layer formed on the first resin layer; and
an interfacial layer which includes a first resin and a second resin and which is formed between the first resin layer and the second resin layer,
wherein the second resin layer comprises a polymer resin having an organic functional group containing one or more oxygen atoms.

14. The melt-processed resin-molded article of claim 13, wherein components of the first resin layer on a surface of the second resin layer are detected by means of an infrared (IR) spectrometer.
